(19) United States
(12) Patent Application Publication
(10) Pub. No.: US 2012/0011384 A1
(43) Pub. Date: Jan. 12, 2012

(54) Network Apparatus Having Routing Function and Power Management Method Thereof

(75) Inventor: MING TANG LEE, HSINCHU (TW)

(73) Assignee: NETKLASS TECHNOLOGY, INC., HSINCHU (TW)

(21) Appl. No.: 12/893,172

(22) Filed: Sep. 29, 2010

(30) Foreign Application Priority Data
Jul. 9, 2010 (TW) 099122616

(51) Int. Cl. G06F 1/32

(52) U.S. Cl. 713/323

(57) ABSTRACT

A power management method for a USB system comprises the steps of: detecting a connecting condition between the USB host and the USB device, reading a descriptor of the USB device, monitoring status of the USB host, selecting an operating mode of the USB device according to the status of the USB host, and selecting a corresponding transmission type via a USB port to transmit a control signal to the USB device so as to switch the operation mode of the USB device.

### BACKGROUND OF THE INVENTION

1. Field of the Invention

The present invention relates to a network apparatus having routing function and the power management method thereof.

2. Description of the Related Art

Recently, the rapid increase in the number of Internet users, various service demands from users, implementation of new services, such as voice-over-IP (VoIP) service or streaming applications, and development of mobile Internet all cause the network structure to become increasingly complex. When data packets are transferred from one node to another, they may pass through numerous networks. Therefore, an accurate and efficient routing mechanism over networks is required for selecting different transmission paths to send packets. A network apparatus to adaptively route packets, known as a router, receives packets transmitted over the network, checks the target address codes of data messages, and selects a best path to the packet's destination according to the packet's size and priority.

In addition to the above functions, routers can perform network traffic control. The main work of the router is to select the best routing path between nodes of a network and to send packets to their destinations more efficiently. In addition, the router can perform scheduling schemes to establish the work to be scheduled. The router also has a load balancing mechanism to balance the workload of multiple servers so as to prevent any individual server from being overloaded due to excessive service demands, or idled due to few service demands. With such mechanism, the data throughput over the network can be increased, and the response time of the user demand can be reduced.

New generation routers integrate multi-media and other software applications. Users can connect an apparatus, such as a printer, scanner, or external hard disk, to a USB (Universal Serial Bus) connecting port of the router to share the apparatus by internet. For example, when a router having a USB connecting port has a built-in printer server, a user can install an internet printer setup program from a compact disc and connect a printer to the router following the setup steps, allowing the printer to be adopted as an internet printer for use in a local area network (LAN).

As multiple functions are integrated into the router, the power consumption increases accordingly. Since a portable communication apparatus usually has a limit to allowable power consumption, high efficiency power management is important in such apparatus. The power consumption of the portable communication apparatus can be reduced, and thus the lifetime of the apparatus can be extended with effective power management. Therefore, there is a need to provide a power management method for the network apparatus having routing function to solve the aforementioned problems.

### SUMMARY OF THE INVENTION

A network apparatus having routing function and the power management method thereof are disclosed. One embodiment of the present invention discloses a network apparatus having routing function, which connects to at least one external apparatus by a USB port. The network apparatus comprises a network service detecting unit, a traffic detecting unit, a timing unit, a mode control unit, and a detecting and read unit. The network service detecting unit is configured to detect the network connection status of at least one WAN port of the network apparatus. The traffic detecting unit is configured to detect the traffic of the network apparatus. The timing unit is configured to determine at least one idle period according to output signals of the network service detecting unit and the traffic detecting unit. The mode control unit is configured to generate a control signal to the external apparatus by the USB port according to the output signals of the network service detecting unit, the traffic detecting unit and the timing unit, so that the external apparatus is controlled to operate in an active mode, a standby mode, or a power saving mode. The power consumption of the network apparatus in the standby mode is less than that of the network apparatus in the active mode, and the external apparatus suspends operation in the power saving mode.

Another embodiment of the invention discloses a network apparatus having routing function, which connects to at least one external apparatus by a USB port. The network apparatus comprises a network service detecting unit, a scheduling unit and a mode control unit. The network service detecting unit is configured to detect the network connection status of at least one WAN port of the network apparatus. The scheduling unit is configured to determine first, second, third, and fourth scheduling periods. The mode control unit is configured to generate a control signal to the external apparatus by the USB port according to the output signals of the network service detecting unit and the scheduling unit, so that the external apparatus is controlled to operate in an active mode, a standby mode, or a power saving mode. The power consumption of the network apparatus in the standby mode is less than that of the network apparatus in the active mode, and the external apparatus suspends operation in the power saving mode.

Another embodiment of the invention discloses a power management method of a USB system, wherein the USB system comprises a USB host with routing function and a USB device. The method comprises the steps of: detecting a connecting condition between the USB host and the USB device, reading a descriptor of the USB device, monitoring status of the USB host, selecting an operating mode of the USB device according to the status of the USB host, and selecting a corresponding transmission type via a USB port to transmit a control signal to the USB device so as to switch the operation mode of the USB device.

The foregoing has outlined rather broadly the features of the present disclosure in order that the detailed description of the disclosure that follows may be better understood. Additional features and advantages of the disclosure will be described hereinafter, and form the subject of the claims of the invention. It should be appreciated by those skilled in the art that the conception and specific embodiment disclosed may be readily utilized as a basis for modifying or designing other structures or processes for carrying out the same purposes as those of the present disclosure. It should also be realized by those skilled in the art that such equivalent constructions do not depart from the spirit and scope of the invention as set forth in the appended claims.

### BRIEF DESCRIPTION OF THE DRAWINGS

The accompanying drawings illustrate several embodiments of the invention and, together with the description, serve to explain the principles of the invention. Those skilled in the art will recognize that the particular embodiments illustrated in the drawings are merely exemplary, and are not intended to limit the scope of the present invention.

FIG. 1 shows a block diagram of a USB system according to one embodiment of the present invention;

FIG. 2 shows a flowchart of a power management method for a USB system according to one embodiment of the present invention;

FIG. 3 shows a data structure of a device descriptor;

FIG. 4 shows a mode switching state diagram of the first USB device when the USB host operates in a smart mode;

FIG. 5 shows a block diagram of a USB system according to another embodiment of the present invention;

FIG. 6 shows a mode switching state diagram of the third USB device when the USB host operates in the scheduling mode; and

FIG. 7 shows a display of the GPI of the USB host according to one embodiment of the present invention.

### PREFERRED EMBODIMENT OF THE PRESENT INVENTION

One aspect of the present disclosure proposes a network device having routing function and the power management method thereof. In order to provide a thorough understanding of the present disclosure, a detailed description of a number of method steps and components is provided below. Clearly, the practice of the present disclosure is not limited to any specific detail of a combination wireless system that is familiar to one skilled in the art. On the other hand, components or method steps which are well-known are not described in detail to avoid unnecessary limitations. A preferred embodiment of the present disclosure will be described in detail. However, in addition to the preferred embodiment described, other embodiments can be broadly employed, and the scope of the present disclosure is not limited by any of the embodiments, but should be defined in accordance with the following claims and their equivalent.

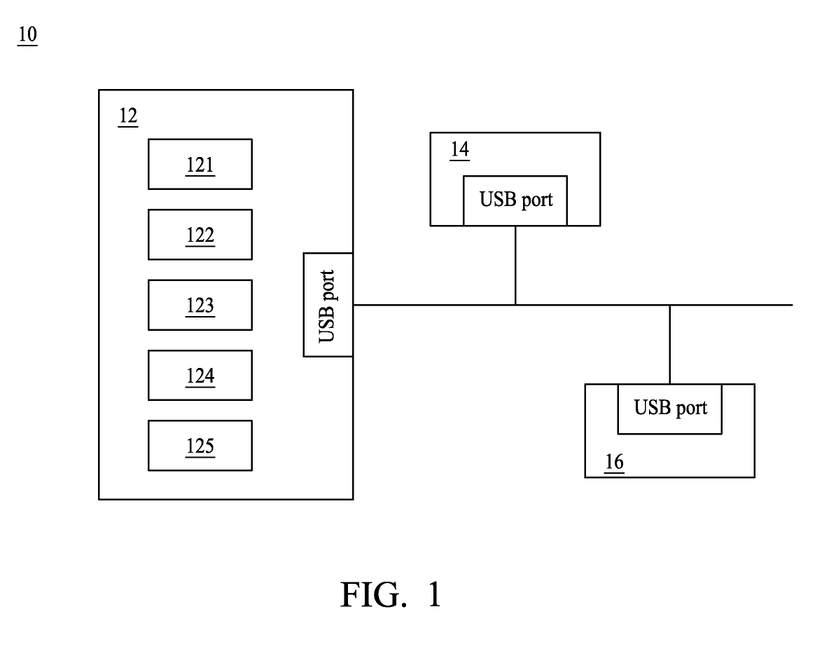

In order to explain the power management method of the present invention more clearly, a USB system will be described that performs the method of the present invention. USB interface is becoming a current market trend due to features such as a hot plug and plug-and-play operation. FIG. 1 shows a block diagram of a USB system 10 according to one embodiment of the present invention. The USB system 10 comprises a USB host 12 having routing function, a first USB device 14, and a second USB device 16. The USB host 12 has at least one WAN (Wide Area Network) port. The first and second USB devices can be, but are not limited to, a keyboard, a computer mouse, a cable modem, or a wireless network card, which connects to the USB host 12 by a USB port. Referring to FIG. 1, the USB host 12 comprises a network service detecting unit 121, a traffic detecting unit 122, a timing unit 123, a mode control unit 124, and a detecting and read unit 125.

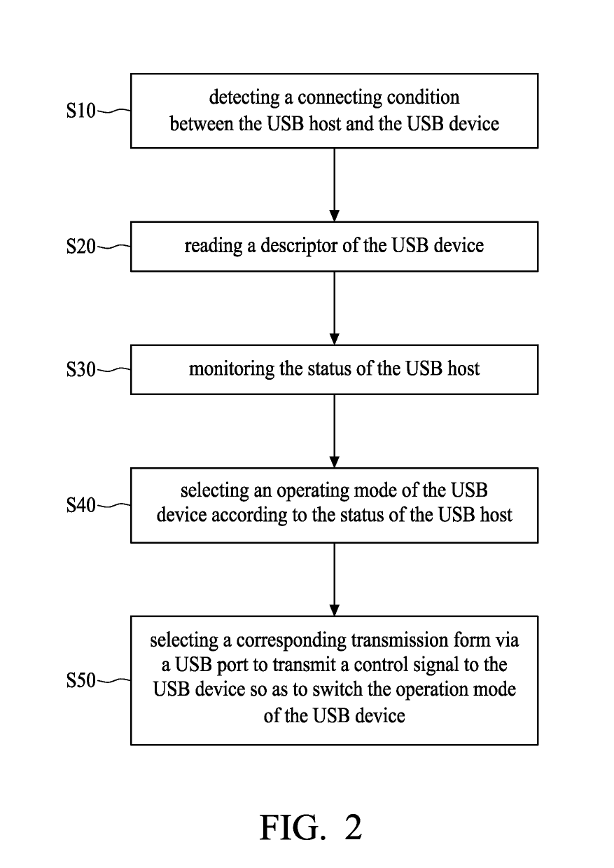

FIG. 2 shows a flowchart of a power management method for a USB system according to one embodiment of the present invention, wherein the USB system comprises a USB host having routing function and a USB device. The power management method comprises detecting a connecting condition between the USB host and the USB device in step S10, reading a descriptor of the USB device in step S20, monitoring the status of the USB host in step S30, selecting an operating mode of the USB device according to the status of the USB host in step S40, and selecting a corresponding transmission form via a USB port to transmit a control signal to the USB device so as to switch the operation mode of the USB device in step S50. The details of the power management method for USB system of the present invention are described in accordance with FIG. 1.

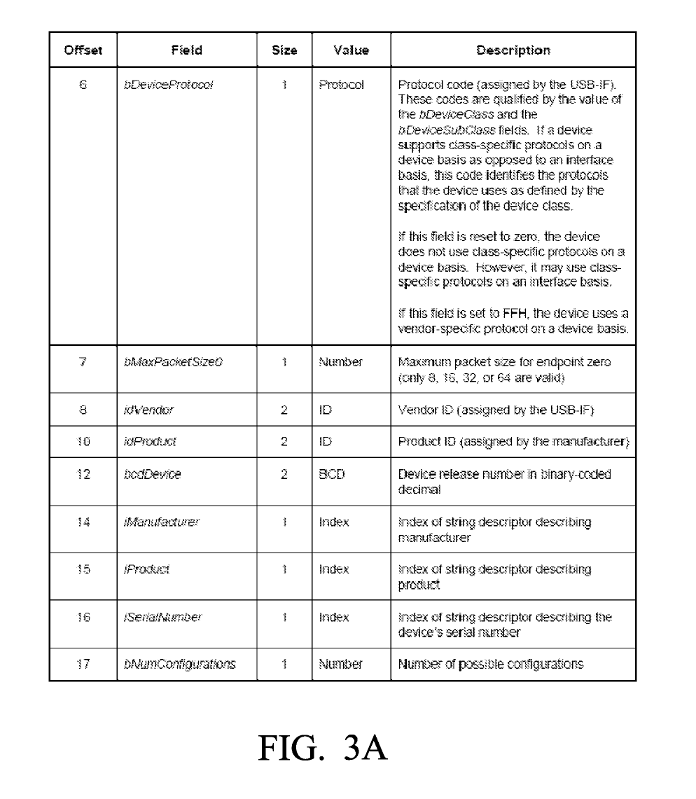

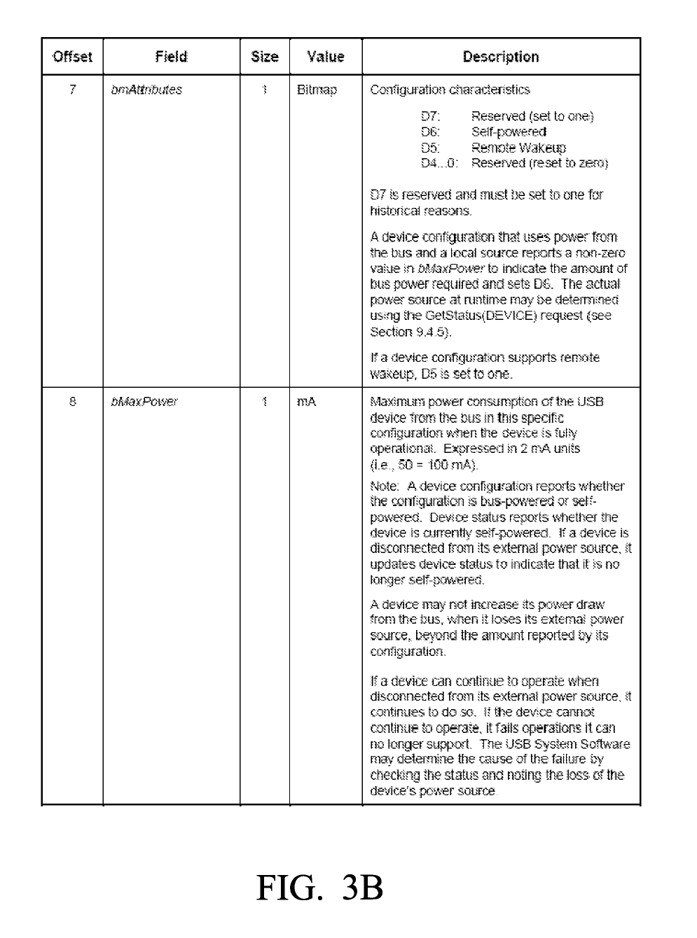

In step S10, the USB host 12 detects the attachment of a peripheral, such as the first USB device 14, by the detecting and read unit 125. When connecting to the USB host 12, the first USB device 14 reports its attributes to the USB host 12 using descriptors. Referring to FIGS. 3A and 3B, a descriptor is a data structure with a defined format and describes general information to the USB host 12 about the attached USB device 14. It includes information that applies globally to the USB device 14 and all of the device's configurations. Fields included within the standard device descriptor comprise a vendor identification assigned by USB (“idVendor”), a product identification assigned by the manufacturer (“idProduct”), USB attributes (“bmAttributes”), and maximum power requirement (“bMaxPower”). Once the detecting and read unit 125 detects the attachment of the first USB device 14, the host device 12 reads the descriptor of the USB device 14 to complete an enumeration procedure of the first device 14. After that, the USB host 12 generates a corresponding transmission form to transmit a control signal to the first USB device 14 so as to communicate and control the operation of the USB device 14.

Referring to FIG. 1, the network service detecting unit 121 and the traffic detecting unit 122 of the USB host 12 are configured to monitor the status of the USB host 12. For example, the network connection status of the at least WAN port of the USB host 12 is detected by the network service detecting unit 121, and the traffic of the USB host 12 is detected by the traffic detecting unit 122. Based on the status of the USB host 12, the mode control unit 124 selects the operation modes, including an active mode, a standby mode, and a power saving mode, of the first USB device 14.

When the first USB device 14 operates in the active mode, the USB host 12 supplies power continuously to the first USB device 14 by the corresponding USB port. The USB host 12 maintains the network connection status, and the network service detecting unit 121 and the traffic detecting unit 122 of the USB host 12 monitor the network connection status of the USB host 12 continuously. When the first USB device 14 operates in the standby mode, the USB host 12 continues to supply power to the first USB device 14 by the corresponding USB port, and the network service detecting unit 121 and the traffic detecting unit 122 of the USB host 12 continue to monitor the network connection status of the USB host 12. When the first USB device 14 operates in the standby mode, the USB host 12 and the first USB device 14 can be disconnected, and the USB host 12 continuously monitors the network connection status and the traffic of its WAN port to determine whether it will recover the connection with the first USB device 14 or not. When the first USB device 14 operates in the standby mode, the power consumption is less than the device 14 operating in the active mode. In addition, to minimize power consumption, the first USB device 14 can operate in the power-saving mode. In this case, the USB host 12 stops supplying power, and the first USB device 14 stops the current operation. The USB host 12 enables a periodic self test function to determine when to resume the power supply and network connection status.

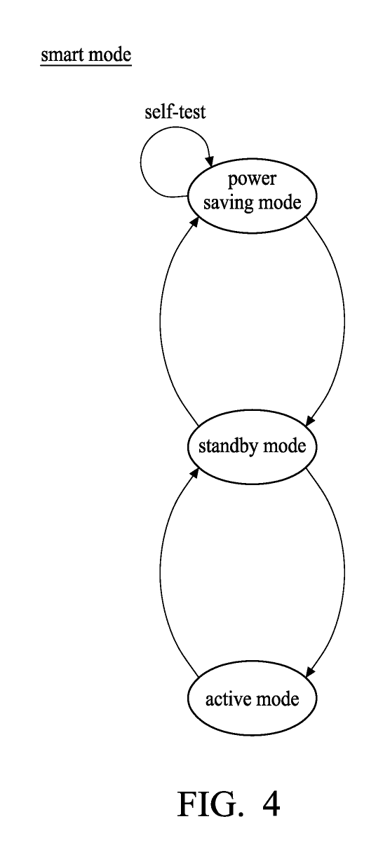

In accordance with an exemplary embodiment of the present disclosure, FIG. 4 shows a mode switching state diagram of the first USB device 14 when the USB host 12 operates in a smart mode. In this case, the first USB device 14 may operate in an active mode, a standby mode, or a power saving mode. When the first USB device 14 operates in the active mode, once the network service detecting unit 121 detects that the at least one WAN port of the USB host 12 is under a network connection status and the traffic detecting unit 122 of the USB host 12 detects that the traffic of the WAN port is less than a threshold value, for example, 2048K bps, the timing unit 123 of the USB host 12 determines a first idle period, for example, 10 minutes. If the above two conditions are satisfied within the first idle period, the mode control unit 124 of the USB host 12 transmits a control signal CT1 to the first USB device 14 by the corresponding USB port to switch the operation mode of the first USB device 14 from the active mode to the standby mode so as to reduce the power consumption of the USB host 12. According to one embodiment of the present invention, the operation current of the USB host 12 can be reduced to 350 mA-450 mA when the supply voltage is 5V.

When the first USB device 14 enters the standby mode, once the network service detecting unit 121 detects that the at least one WAN port of the USB host 12 is in a network connection state and the traffic detecting unit 122 of the USB host 12 detects that the traffic of the WAN port remains less than the threshold value, the timing unit 123 of the USB host 12 determines a second idle period, for example, 15 minutes. If the above two conditions are satisfied within the second idle period, the mode control unit 124 of the USB host 12 transmits a control signal CT2 to the first USB device 14 by the corresponding USB port to switch the operation mode of the first USB device 14 from the standby mode to the power saving mode.

When the first USB device 14 enters the power saving mode, once the WAN port of the USB host 12 is disconnected and the USB device 12 returns to a network connection status, the first USB device 14 switches the operation mode from the power saving mode to the standby mode so as to receive the power supply of the USB host 12. After the USB host 12 receives the power supply, the detecting and read unit 125 can detect the attachment of the first USB device 14. Subsequently, the USB host 12 switches the operation mode of the first USB device 14 from the standby mode to the active mode by a control signal CT3.

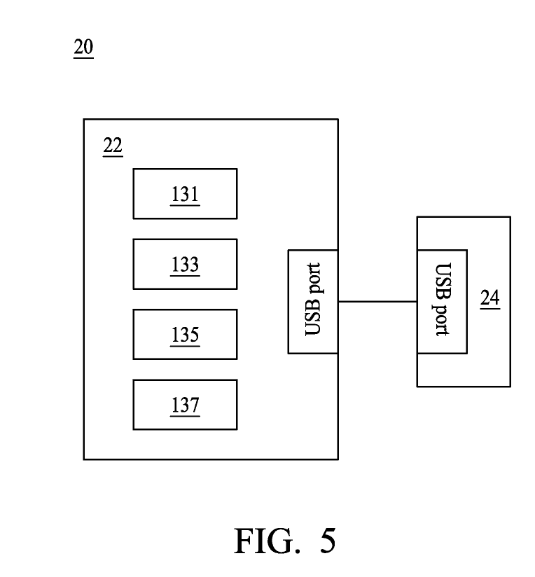

According to another embodiment of the present invention, a USB system 20, as shown in FIG. 5, comprises a USB host 22 having routing function and a third USB device 24, wherein the USB host 22 operates in a scheduling mode. The USB host 22 comprises a network service detecting unit 131, a scheduling unit 133, a mode control unit 135, and a detecting and read unit 137. The network service detecting unit 131 is configured to detect the network connection status of at least one WAN port of the USB host 22, and the scheduling unit 133 is configured to determine a plurality of scheduling periods.

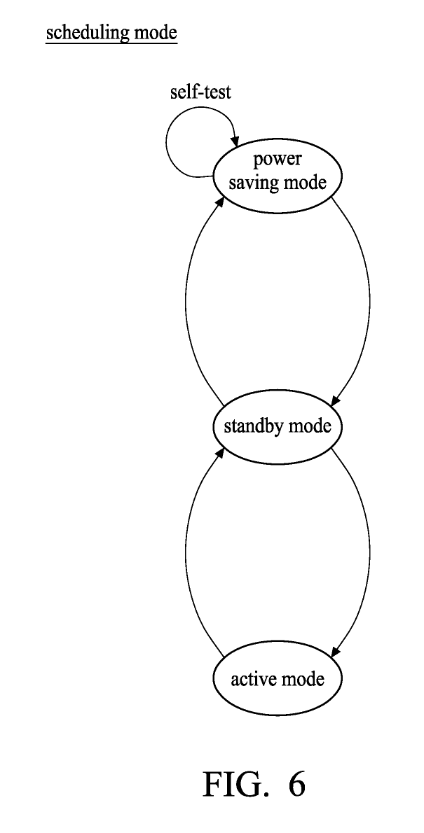

In accordance with an exemplary embodiment of the present disclosure, FIG. 6 shows a mode switching state diagram of the third USB device 24 when the USB host 22 operates in the scheduling mode, wherein the third USB device 24 may operate in an active mode, a standby mode, or a power saving mode.

When the third USB device 24 operates in the active mode, once the USB host 22 reaches beginning of the first scheduling period set by the scheduling unit 133, the mode control unit 135 of the USB host 22 sends a control signal CT4 to the third USB device 24 by the corresponding USB port to switch the operation mode of the third USB device 24 from the active mode to the standby mode so as to reduce the power consumption of the USB host 22.

When the third USB device 24 operates in the standby mode, once the USB host 22 reaches the beginning of the second scheduling period set by the scheduling unit 133, the mode control unit 135 of the USB host 22 sends a control signal CT5 to the third USB device 24 by the corresponding USB port to switch the operation mode of the third USB device 24 from the standby mode to the power saving mode.

When the third USB device 24 operates in the power saving mode, once the USB host 22 reaches the beginning of the third scheduling period set by the scheduling unit 133 or the WAN port of the USB host 22 is disconnected and returns to a network connection status, the third USB device 24 switches the operation mode from the power saving mode to the standby mode so as to receive the power supply of the USB host 22. After the USB host 22 begins to supply power, once the USB host 22 reaches the beginning of the fourth scheduling period set by the scheduling unit 133 or the WAN port of the USB host 22 returns to a network connection status, the USB host 22 switches the operation mode of the third USB device 24 from the standby mode to the active mode by a control signal CT6.

The plurality of scheduling periods and the threshold values are set according to a built-in profile database of the USB host according to one embodiment of the present invention. The profile database is built according to the feature values, such as USB attributes or maximum power requirement, of the known or anticipated USB devices. The operation mode and the switching mechanism of the peripherals of the USB host can be determined according to predetermined values of the built-in profile database.

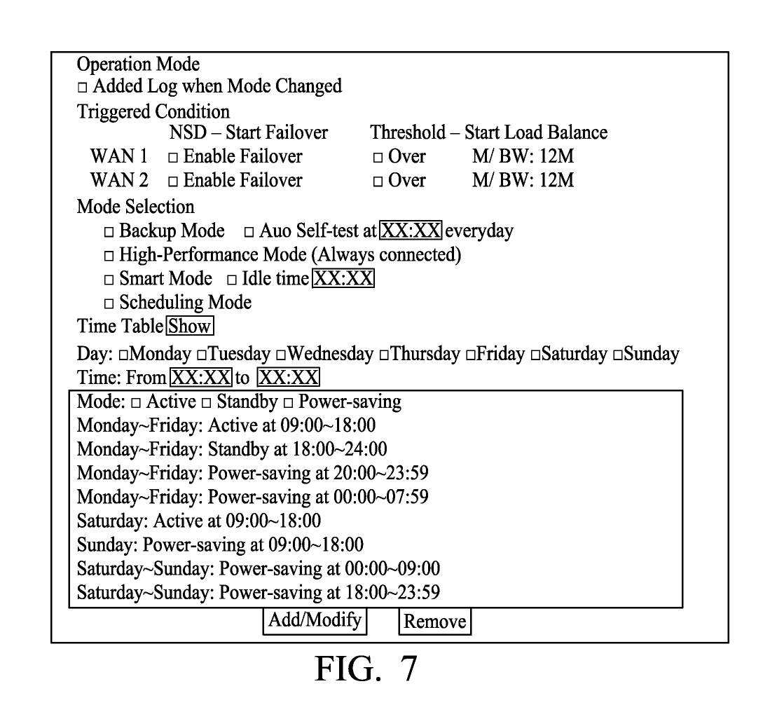

Accordingly to another embodiment of the present invention, the operation mode and the switching mechanism of the peripherals of the USB device can be selected according to an operation menu shown on a graphic programming interface (GPI) of the USB host. FIG. 7 shows a display of the GPI of the USB host according to one embodiment of the present invention. A user can select to detect the network connection status of a first WAN port or/and a second WAN port based on the operation menu. If the amount of traffic of the first WAN port or the second WAN port is greater than a threshold value, the USB host performs load balancing on the first WAN port and the second WAN port to share the load. In addition, when a user directs the USB host to operate in a scheduling mode, the user can set the scheduling period during which the peripherals of the USB host operate in an active mode, a standby mode, or a power saving mode, based on the operation menu. Also, the user can set the time interval for which the USB host executes a self test function and set the idle time when the USB host operates in a smart mode based on the operation menu.

The above-described embodiments of the present disclosure are intended to be illustrative only. Numerous alternative embodiments may be devised by persons skilled in the art without departing from the scope of the following claims.

What is claimed is:

1. A network apparatus having routing function, which connects to at least one external apparatus by a Universal Serial Bus (USB) port, the network apparatus comprising:
a network service detecting unit configured to detect a network connection status of at least one wide area network (WAN) port of the network apparatus;
a traffic detecting unit configured to detect the traffic of the network apparatus;
a timing unit configured to determine at least one idle period according to output signals of the network service detecting unit and the traffic detecting unit; and
a mode control unit configured to generate a control signal to the external apparatus by the USB port according to the output signals of the network service detecting unit, the traffic detecting unit and the timing unit, so that the external apparatus is controlled to operate in an active mode, a standby mode, or a power saving mode;
wherein the power consumption of the network apparatus in the standby mode is less than that of the network apparatus in the active mode, and the external apparatus stops operation in the power saving mode.

2. The network apparatus of claim 1, further comprising a detecting and read unit configured to read a device descriptor of the external apparatus after detecting that the external apparatus is connected to the network apparatus, wherein the network apparatus selects a corresponding transmission form to send the control signal to the external apparatus according to the device descriptor.

3. The network apparatus of claim 2, wherein the device descriptor comprises vendor identification and product identification to identify the external apparatus, and comprises USB attributes and maximum power requirement to obtain the power supply property of the external apparatus.

4. The network apparatus of claim 1, wherein when the external apparatus operates in the active mode, once the WAN port of the network apparatus is in a network connection status during the first idle period and the traffic of the network apparatus is less than a threshold value during the first idle period, the external apparatus switches from the active mode to the standby mode after the first idle period.

5. The network apparatus of claim 1, wherein when the external apparatus operates in the standby mode, once the WAN port of the network apparatus is in a network connection status during the second idle period and the traffic of the network apparatus is less than the threshold value during the second idle period, the external apparatus switches from the standby mode to the power saving mode after the second idle period.

6. The network apparatus of claim 1, wherein when the external apparatus operates in the power saving mode, once the WAN port of the network apparatus is disconnected and the network apparatus returns to a network connection status, the external apparatus switches from the power saving mode to the standby mode so as to receive the power supply of the network apparatus, and after detecting the attachment of the external apparatus, the network apparatus switches the operation mode of the external apparatus from the standby mode to the active mode by the control signal.

7. The network apparatus of claim 1, wherein when the external apparatus operates in the power saving mode, a self test function is executed at a constant time interval, and when the external apparatus operates in the active mode, the network apparatus performs a load balancing mechanism on the WAN ports according to the traffic of the WAN ports.

8. The network apparatus of claim 1, wherein when the WAN port of the network apparatus is in a network connection status and the amount of traffic of the network apparatus is greater than the threshold value, the external apparatus enters the active mode

9. The network apparatus of claim 1, further comprising a display unit to provide functional options.

10. A network apparatus having routing function, which connects to at least one external apparatus by a Universal Serial Bus (USB) port, the network apparatus comprising:
a network service detecting unit configured to detect the network connection status of at least one wide area network (WAN) port of the network apparatus;
a scheduling unit configured to determine first, second, third, and fourth scheduling periods; and
a mode control unit configured to generate a control signal to the external apparatus by the USB port according to the output signals of the network service detecting unit and the scheduling unit, so that the external apparatus is controlled to operate in an active mode, a standby mode, or a power saving mode;
wherein the power consumption of the network apparatus in the standby mode is less than that of the network apparatus in the active mode, and the external apparatus suspends operation in the power saving mode.

11. The network apparatus of claim 10, further comprising a detecting and read unit configured to read a device descriptor of the external apparatus after detecting that the external apparatus is connected to the network apparatus, wherein the network apparatus selects a corresponding transmission form to send the control signal to the external apparatus according to the device descriptor.

12. The network apparatus of claim 11, wherein the device descriptor comprises vendor identification and product identification to identify the external apparatus, and comprises USB attributes and maximum power requirement to obtain the power supply property of the external apparatus.

13. The network apparatus of claim 10, wherein when the external apparatus operates in the active mode, once the network reaches the first scheduling period, the external apparatus switches from the active mode to the standby mode.

14. The network apparatus of claim 10, wherein when the external apparatus operates in the standby mode, once the network reaches the second scheduling period, the external apparatus switches from the standby mode to the power saving mode.

15. The network apparatus of claim 10, wherein when the external apparatus operates in the power saving mode, once the network reaches the third scheduling period, or the WAN port of the network apparatus is disconnected and the network apparatus returns to a network connection status, the external apparatus switches from the power saving mode to the standby mode so as to receive the power supply of the network apparatus.

16. The network apparatus of claim 10, wherein when the external apparatus operates in the standby mode, once the network reaches the fourth scheduling period, or the network apparatus returns to a network connection status, the external apparatus switches from the standby mode to the active mode.

17. The network apparatus of claim 10, wherein when the external apparatus operates in the power saving mode, a self test function is executed at a constant time interval, and when the external apparatus operates in the active mode, the network apparatus performs a load balancing mechanism on the WAN ports according to the traffic of the WAN ports.

18. The network apparatus of claim 10, further comprising a display unit to provide functional options.

19. A power management method of a Universal Serial Bus (USB) system, wherein the USB system comprises a USB host having routing function and a USB device, the method comprising the steps of:
detecting a connecting condition between the USB host and the USB device;
reading a descriptor of the USB device in step S20, monitoring the status of the USB host;
selecting an operating mode of the USB device according to the status of the USB host; and
selecting a corresponding transmission type via a USB port to transmit a control signal to the USB device so as to switch the operation mode of the USB device.

20. The power management method of claim 19, wherein the selecting step is performed by the USB host according to a built-in profile database.

21. The power management method of claim 19, wherein the selecting step is performed by a user according to an operation menu shown on a graphic programming interface of the USB host.

22. The power management method of claim 19, wherein the device descriptor comprises vendor identification and product identification to identify the external apparatus, and comprises USB attributes and maximum power requirement to obtain the power supply property of the external apparatus.

23. The power management method of claim 19, wherein the operating modes comprises an active mode, a standby mode, and a power saving mode, the power consumption of the USB host in the standby mode is less than that of the USB host in the active mode, and the USB device suspends operation in the power saving mode.
